(19) United States
(12) Patent Application Publication
(10) Pub. No.: US 2022/0405936 A1
(43) Pub. Date: Dec. 22, 2022

(54) Computer-implemented method for segmenting measurement data from a measurement of an object

(71) Applicant: Volume Graphics GmbH, Heidelberg (DE)

(72) Inventors: Christoph POLIWODA, Heidelberg (DE); Sören SCHÜLLER, Heidelberg (DE)

(21) Appl. No.: 17/778,800

(22) PCT Filed: Nov. 18, 2020
(86) PCT No.: PCT/EP2020/082539

§ 371 Date: May 20, 2022

(30) Foreign Application Priority Data
Nov. 21, 2019 (DE) 10 2019 131 452.6

(51) Int. Cl. G06T 7/11; G06T 7/60; G06T 7/30

(52) U.S. Cl. CPC G06T 7/11; G06T 7/60; G06T 7/30

(57) ABSTRACT

Described is method for segmenting measurement data from a measurement of an object having at least one material transition region, the measurement data generating a digital object representation having the at least one material transition region and comprising pieces of spatially-resolved image information of the object. The method comprises: determining the measurement data comprising at least one artefact; determining at least two homogeneous regions in the measurement data and/or in the digital object representation; analysing a local similarity of pieces of spatially resolved image information; adjusting an extent of each homogeneous region until at least one boundary region of each homogeneous region is located at an expected position of a material transition region; segmenting the digital object representation based on the adjusted homogeneous regions. The method improves segmenting measurement data from a measurement of an object having poor data quality, while correctly detecting material transitions from the measurement data.

The invention relates to a computer-implemented method for segmenting measurement data from a measurement of an object.

For quality assurance in order to determine whether objects which have been produced comply with the desired specifications, these objects are measured and are compared with the desired specifications. In this case, the measurement can be carried out as a dimensional measurement, for example. Dimensional measurements can be carried out, for example, by sensing various points on the surface of the object. Further, it is possible to carry out computed tomography measurements, for example, with the measurement data obtained thereby being analyzed. In this case, surfaces inside the objects can also be checked. In this case, the measurement data may be in the form of volume data, for example, or can be converted into volume data. In order to be able to distinguish different regions of the object from one another in the measurement data, the measurement data are segmented into different regions. This is of particular interest, for example, during visualization, reverse engineering, multi-component functional analysis and the simulation of materials and material properties. Furthermore, the measurement data can be preprocessed before carrying out the method, in order to avoid incorrect segmentations on account of artifacts or noise, which can also be referred to as poor data quality. Artifact corrections, for example metal artifact, beam hardening or scattered radiation corrections based on the segmented geometry, and data filters, for example Gaussian or median filters, can be applied to the measurement data, for example.

However, the segmentation of volume data relating to multi-material measurement objects has hitherto not been able to be carried out satisfactorily since specific adaptations of the segmentation algorithms are required for each material transition between two specific materials. For example, when analyzing grayscale values, it is necessary to use lower thresholds for detecting material transitions between materials which have comparatively low grayscale values in the measurement data, than for detecting material transitions between materials which have comparatively high grayscale values in the measurement data. Therefore, there are no good prospects of segmenting these volume data on the basis of a global threshold. In particular, if the measurement data have a poor data quality, for example in the form of artifacts, or small structures, many algorithms cannot correctly segment the different materials. Furthermore, a correct segmentation does not suffice to provide precise measurement results at all material transitions, that is to say to precisely determine the position of the material transitions.

The object of the invention can therefore be considered that of providing an improved computer-implemented method for segmenting measurement data from a measurement of an object which have a poor data quality, with the method providing correct identification of material transitions from the measurement data relating to the object.

Main features of the invention are stated in claims 1 and 15. Claims 2 to 14 relate to embodiments.

According to one aspect of the invention, a computer-implemented method for segmenting measurement data from a measurement of an object is provided, the object having at least one material transition region, a digital object representation with the at least one material transition region being generated by way of the measurement data, the digital object representation having a multiplicity of spatially resolved image information items of the object, the method including the following steps: determining the measurement data, the measurement data containing at least one artifact; determining at least two homogeneous regions in the measurement data and/or in the digital object representation; analyzing a local similarity of the multiplicity of spatially resolved image information items; adapting an extent of each homogeneous region until at least one boundary region of each homogeneous region is arranged at an expected position of a material transition region; segmenting the digital object representation on the basis of the adapted homogeneous regions.

With the invention, different algorithms are used to segment objects whose measurement data contain at least one artifact and hence have a poor data quality. In this case, the algorithms examine different forms of representation of the measurement data relating to the object. Using different algorithms with their respective advantages and disadvantages makes it possible to utilize the strengths of the algorithms used in the best possible way. For example, the image information items from the measurement data can first of all be analyzed using one algorithm, with each image information item being compared with the locally adjacent image information items, for example, in order to determine homogeneous regions. This can be referred to as pre-segmentation. Furthermore, this can be advantageously carried out on three-dimensional measurement data, for example. However, two-dimensional measurement data which can also be linked to the three-dimensional measurement data can also be used. Similar image information items are then combined to form a homogeneous region. At least one homogeneous region is determined in this manner. In this case, an algorithm on which the determination of the homogeneous region is based may be inaccurate, with the result that the positions of the boundaries of the homogeneous region do not coincide with the positions of the material transition regions which could delimit the homogeneous region. A further algorithm can be used to analyze the local similarity of the image information items. The analysis of the local similarity can be used to determine regions in which the image information items only slightly resemble adjacent image information items. These regions can be identified as an expected position of a material transition region. In this case, the expected position may also result, for example, from the target geometry of the object or from another representation of the measurement data. A boundary region of the homogeneous region is then adapted by means of a further algorithm, for example by shifting its position. The extent of the homogeneous region can be changed in the process. The position of the boundary region is adapted until the boundary region comprises an expected position of a material transition region. Disadvantages of individual algorithms can therefore be compensated for by using further algorithms. In this case, a boundary region is understood as meaning a section of the homogeneous region which delimits the homogeneous region. In this case, the boundary region may have a predefined boundary region extent inside the homogeneous region.

In the example, regions having values which exceed a predetermined threshold for the local similarity can be identified as material transition regions between different material regions in the representation of the local similarity. Regions which are delimited by the material transition regions are then completely assigned to that material which had the greatest proportion of this region after the pre-segmentation. In this case, it may also happen that a closed material transition region is not formed between the material regions. This can be closed, for example, by means of a morphological operation of “closing”, in which the relevant material transition regions grow together and small regions in between are removed.

The digital object representation is therefore segmented on the basis of the adapted homogeneous regions between the at least two homogeneous regions. In this case, the determination of the expected positions of a material transition region may have a small search region at the edge of the homogeneous regions in which the material transition regions are searched for. In this case, before the step of segmenting the digital object representation on the basis of the adapted homogeneous regions, which, together with the steps of analyzing a local similarity of the multiplicity of spatially resolved image information items and adapting an extent of each homogeneous region until at least one boundary region of each homogeneous region is arranged at an expected position of a material transition region, can act as main segmentation, for example as comparatively fine segmentation, a pre-segmentation, for example a comparatively coarse segmentation, is carried out. The pre-segmentation may comprise, for example, the step of determining at least two homogeneous regions in the measurement data and/or in the digital object representation, with at least one of the at least two homogeneous regions having a small structure. In this case, in the subsequent main segmentation, material transition regions between the homogeneous regions can be determined, for example, if the local similarity is reduced. Otherwise, the relevant homogeneous regions are combined. In this case, a material transition region may have, for example, a material surface, two abutting material surfaces, a plurality of material transitions separated by narrow material regions or a transition of the inner structure of an individual material etc. The result of this coarse segmentation may be the detection of the extent of homogeneous regions or of regions of a similar texture in the homogeneous regions. The step of segmenting the digital object representation on the basis of the adapted homogeneous regions can then be carried out. Artifacts in the homogeneous regions can be better detected by the combination of the pre-segmentation and the main segmentation than without this combination. Putative material transition regions, which are due to artifacts, can therefore be discarded during the segmentation so that incorrect segmentations are avoided.

In this case, a homogeneous region is understood as meaning a region which has a uniform material or a uniform material mixture. The image information items may be, for example, grayscale values which are obtained from measurement data from a computed tomography measurement during a dimensional measurement of an object.

Further, regions whose measurement data or image information items are, for example, between two thresholds, for example an upper and a lower threshold, that is to say in which the local measurement data are similar or have similar values, that is to say if a local similarity is high, are considered to be homogeneous. The image information items relating to a homogeneous region in the digital object representation can therefore have grayscale values within a narrow range of grayscale values in one example. In the object, these regions may have a uniform material or a uniform material mixture. The homogeneous regions are therefore not absolutely homogeneous, but rather may have fluctuations within a tolerance. The thresholds may be predefined or may be determined when determining the homogeneous regions. However, the homogeneity of the regions need not be defined by means of the grayscale values. In another example, regions having a fibrous material with a similar fiber orientation may also be considered to be homogeneous even if the grayscale values themselves are not homogeneous in this case. However, the pattern which is defined by the texture which results from the fibers is then homogeneous. The material of a region or of the entire object may be, for example, a mono-material, that is to say the material transitions in the material transition regions may then be in this example transitions between different material structures or a transition from the mono-material to the background.

A material transition region may have, for example, a transition between biological materials, welded seams or regions of different fiber orientation. It is not necessary for the material transition region to have a clear material surface. In a further example, a material transition region can be approximated or represented as a surface both in measurements and in a CAD model.

Further, the at least one material transition region may be a multi-material transition region, for example. The term multi-material relates not only to regions of a plurality of homogeneous individual materials. The presence of fibers or porosities may respectively also specify a separate material region within a mono-material even if the underlying material remains identical. Regions of different properties, in particular in the case of an identical or similar material composition, can also be explicitly interpreted as separate materials. The background of a CT scan, usually the air around the object, may likewise be a material in the measurement data.

That is to say, in addition to the image information items representing a background of the object, the object comprises at least two materials in the measurement data for which the material transitions, for example surfaces, are determined.

In a further example, the analysis of the local similarity can be based on a change sequence of the multiplicity of spatially resolved image information items and/or a local variance of the multiplicity of spatially resolved image information items.

If the image information items are grayscale values, for example, the change sequence can represent the gradient of the spatially resolved grayscale values. If the homogeneous regions are based on textures, the local variance of the image information items, for example, can be used to determine the local similarity. In this case, a gradient representation is preferably the absolute value of the local gradient. They indicate increased values in the vicinity of material transition regions.

For example, the method further may include the following step that precedes the determination of at least two homogeneous regions of the digital object representation: aligning a digital representation of a target geometry with the digital object representation, with the determination of at least two homogeneous regions being carried out on the basis of the digital representation of a target geometry.

The expected positions of the material transition regions, for example, can therefore be gathered from the target geometry in order to obtain at least a rough prealignment of the measurement data. In this case, the target geometry may be a CAD model of the object. The regions of the target geometry or of the CAD model can then be assigned to the corresponding regions of the measurement data. The computer-implemented method can therefore resort to previous knowledge from the target geometry when determining the position of the material transitions. This can be carried out as part of a pre-segmentation.

Alternatively or in addition, information relating to the geometry of the object from a measurement using another sensor, for example optical methods such as structured light projection, can also be used.

By way of example, following the step of segmenting the digital object representation, the method may further include the following step: determining the position of the at least one material transition region in the at least one boundary region by means of the at least two homogeneous regions.

In this case, the position of the at least one material transition region can be determined on the basis of an adapted label field. The local material transition region is then calculated with increased accuracy. The position can be defined by coordinates.

In a further example, following the segmentation of the digital object representation, the method may further include the following step: changing an extent of at least one of the homogeneous regions on the basis of a visualization of the homogeneous regions in the digital object representation.

To this end, a user can for example be given the option of manually correcting or processing the homogeneous regions, which may be provided in the form of a label field. This step can be particularly advantageous should the main segmentation not supply the desired result on account of a low data quality of the measurement data. The desired materials are input into the label field directly by the user. Changing the homogeneous region following the segmentation may likewise be carried out by a user, in order to avoid an incorrect segmentation.

In a further example, following the segmentation of the digital object representation, the method may further include the following steps: changing a local similarity of the multiplicity of spatially resolved image information items in the segmented digital object representation for the purposes of correcting the analyzed local similarity; and repeating the step of segmenting the digital object representation on the basis of the corrected analyzed local similarity.

A representation of the local similarity, on the basis of which the label field is calculated, can be processed thereby. Thus, by means of processing, it is possible to define that it is not an entire material transition region that needs to be determined, but only a part, for example an edge, which part can be represented in, or worked into, a representation of the local similarity more easily. In this case, the local similarity of the multiplicity of spatially resolved image information items in the segmented digital object representation can be changed by means of a user input for the purposes of correcting the analyzed local similarity.

Furthermore, it is possible to highlight regions in which material transition regions are present in a user's opinion. In this case, anchor points can be set, with the processing being able to be carried out as a material transition region and as meta-information, or the image information items being changed directly in the representation of the local similarity.

Alternatively, erroneous material transition regions can also be removed or weakened. After processing, the label field is recalculated on this basis. In this case, it is also possible to output a warning if no meaningful material transition region can be found at the location defined by the user.

In a further example, the step of adapting an extent of each homogeneous region until at least one boundary region of each homogeneous region is arranged at an expected position of a material transition region may include the following sub-steps: determining at least one artifact region containing at least one artifact in the digital object representation on the basis of the at least two homogenous regions and/or a digital representation of a target geometry; determining at least one boundary region on the basis of the analyzed local similarity, with a boundary region being determined in the artifact region if the local similarity between the image information items is lower than outside of the at least one artifact region.

Consequently, regions in the measurement data in which there should be artifacts or image defects or, in general, a low data quality can be predicted. The idea is then to tend to identify a material transition region less often in these regions during the main segmentation so that incorrect segmentations are avoided. The representation of the local similarity images rampart-like structures in the process, and these are used as boundary regions in the material transition regions. Some artifacts, for example streak artifacts, may likewise cause representations of rampart-like structures, which may then be incorrectly determined as boundary regions. This can be avoided by manipulating the values of the local similarity in the artifact regions.

To predict the regions of low data quality in the measurement data, in which these measures may be taken, use can be made here of a geometry which is obtained from a segmentation, optionally a preliminary segmentation, or a CAD model. On account of previous knowledge about the determination step for the measurement data, this for example allows predictions to be made as to where artifacts such as streak artifacts or noise on account of a significant transillumination length will occur.

By way of example, the target geometry can be a CAD model in this case. Further, the local similarity of the image information items is increased in the at least one artifact region or stricter criteria for the presence of a boundary region are used in the step of determining at least one boundary region such that the tendency is to identify a material transition region less often.

In a further example, the step of adapting an extent of each homogeneous region until at least one boundary region of each homogeneous region is arranged at an expected position of a material transition region may include the following sub-steps: determining at least one geometry type of a volume region of the digital object representation; comparing the determined geometry type with geometry types from a target geometry of the object; determining at least one boundary region on the basis of the analyzed local similarity, with a boundary region being determined in the volume region if the local similarity between the image information items is lower than outside of the volume region and if the determined geometry type is not similar to any of the geometry types from the target geometry of the object.

The term geometry type is understood to mean different types and shapes of geometries. Thus, a geometry type may represent, e.g., surfaces or free forms with a defined curvature or bodies. Further, a geometry type may for example describe a material structure, such as, e.g., a foam structure or a solid structure.

In this case, the representation of the local similarity is analyzed in respect of its geometry types and compared to the geometry types that should be present in the object. Accordingly, it is known that geometry types of a certain style cannot be present in the object. By way of example, these geometry types could be plane surfaces in foam structures. Corresponding volume regions of reduced local similarity which reproduce such geometries are accordingly identified less frequently as a material transition region in the main segmentation.

According to a further example, the step of adapting an extent of each homogeneous region until at least one boundary region of each homogeneous region is arranged at an expected position of a material transition region may include the following sub-steps: determining a quality value of at least one volume region of the digital object representation; determining at least one boundary region on the basis of the analyzed local similarity in the volume region if the local similarity between the image information items is lower than outside of the volume region and if the determined quality value for the at least one volume region is smaller than a predefined threshold for the quality value.

In this case, a type of quality or uncertainty of the grayscale value specification can be calculated, by means of the quality value, for each voxel or volume region. By way of example, real projection data are compared to a forward projection, for example a calculated projection on the basis of the reconstruction, in this case. From this, it is possible to estimate the volume regions in which the data quality is expected to be low since the measurement data are not consistent or have great uncertainty in these volume regions. The predefined threshold can be specified by a user or an evaluation plan, for example.

Further, the method may for example include the following step: repeating the steps of: adapting the multiplicity of image information items in the segmented digital object representation by means of an artifact correction method based on the determined homogeneous regions and segmenting the digital object representation on the basis of the multiplicity of adapted image information items for as long as a predefined repetition condition is satisfied.

Some algorithms for correcting artifacts, for example metal artifact correction, beam hardening correction or scattered radiation correction, use prior knowledge about the measured geometry of the object or of the volume in which the object is measured. Since a high-quality segmentation of the multi-material object now is present, this segmentation can be used for this geometry. Such corrections exploit knowledge about the geometry of the object in order to obtain improved measurement data, for example volume data, optionally via the detour by way of corrected projection data. Accordingly, the multi-material segmentation allows the corrections to be carried out in optimized fashion. A new, more accurate segmentation is possible on the basis of the corrected measurement data. By way of example, the repetition condition may include a specified number of repetitions, the comparison with a threshold for the number of artifacts in the digital object representation or the probability for the presence of artifacts in the digital object representation or the influence of artifacts on the correctness of the found material transition regions.

Further, the method may for example include the following step: repeating the steps of: adapting the multiplicity of image information items in the segmented digital object representation by means of an artifact correction method based on the determined homogeneous regions and segmenting the digital object representation on the basis of the multiplicity of adapted image information items for as long as a predefined repetition condition is satisfied.

Hence, the steps of: adapting the multiplicity of image information items in the segmented digital object representation by means of an artifact correction method based on the determined homogeneous regions and segmenting the digital object representation on the basis of the multiplicity of adapted image information items for as long as a predefined repetition condition is satisfied are carried out iteratively on the basis of corrected data and a new segmentation.

Furthermore, a material can be assigned to each homogeneous region following the segmentation of the digital object representation, for example.

By way of example, this can be carried out on the basis of a list, which may be grayscale value-based for example, or on the basis of the segmented geometries, the geometries being able to be assigned to homogeneous regions in the measurement data on the basis of a parts catalog. Hence, further information items about the materials can be provided to the model-based corrections, in particular in combination with the steps of adapting the multiplicity of image information items in the segmented digital object representation by means of an artifact correction method based on the determined homogeneous regions and segmenting the digital object representation on the basis of the multiplicity of adapted image information items for as long as a predefined repetition condition is satisfied, and a repetition of these steps. The provided information items about the materials are particularly helpful for the artifact correction methods, especially for the model-based artifact correction methods, since the information items about the materials facilitate more accurate results. Further, it is hence also possible to use artifact correction methods which require information items about the materials present in the object in addition to the information items about the geometry of an object. In particular, the assignment of a material can be carried out after determining the position of the at least one material transition region in the at least one boundary region by means of the at least two homogeneous regions.

Further, following the segmentation of the digital object representation, the method may for example further include the following step: performing a dimensional measurement in the segmented digital object representation on the basis of the boundary regions.

Especially in combination with the method steps of determining the measurement data, the measurement data containing at least one artifact; determining at least two homogeneous regions in the measurement data and/or in the digital object representation; analyzing a local similarity of the multiplicity of spatially resolved image information items; adapting an extent of each homogeneous region until at least one boundary region of each homogeneous region is arranged at an expected position of a material transition region; segmenting the digital object representation on the basis of the adapted homogeneous regions, an accurate position of a material transition region, for example a surface, is provided despite the low data quality. If material transition regions were determined, the dimensional measurement can then be carried out by means of the material transition regions. In particular, a dimensional measurement in the segmented digital object representation on the basis of the boundary regions can be carried out after determining the position of the at least one material transition region in the at least one boundary region by means of the at least two homogeneous regions.

In a further aspect, the invention relates to a computer program product with instructions which are executable on a computer and which when executed on a computer prompt the computer to carry out the method according to the description above.

Advantages and effects as well as developments of the computer program product result from the advantages and effects as well as developments of the method described above. Reference is therefore made to the preceding description in this respect. A computer program product can be understood as meaning, for example, a data storage medium which stores a computer program element which has instructions which can be executed for a computer. Alternatively or in addition, a computer program product may also be understood as meaning, for example, a permanent or volatile data memory such as a flash memory or a main memory which has the computer program element. However, further types of data memories which have the computer program element are not excluded thereby.

Further features, details and advantages of the invention emerge from the wording of the claims and from the following description of exemplary embodiments on the basis of the drawings, in which:

FIG. 1 shows a flowchart of the computer-implemented method;

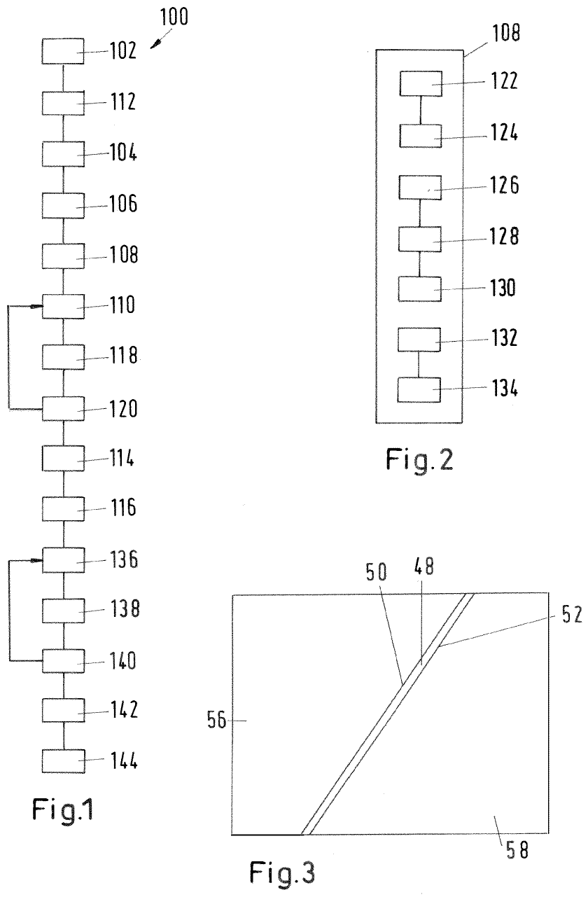

FIG. 2 shows a flowchart with sub-steps of an exemplary embodiment of the adapting step;

FIG. 3 shows a schematic representation of a multi-material transition region; and

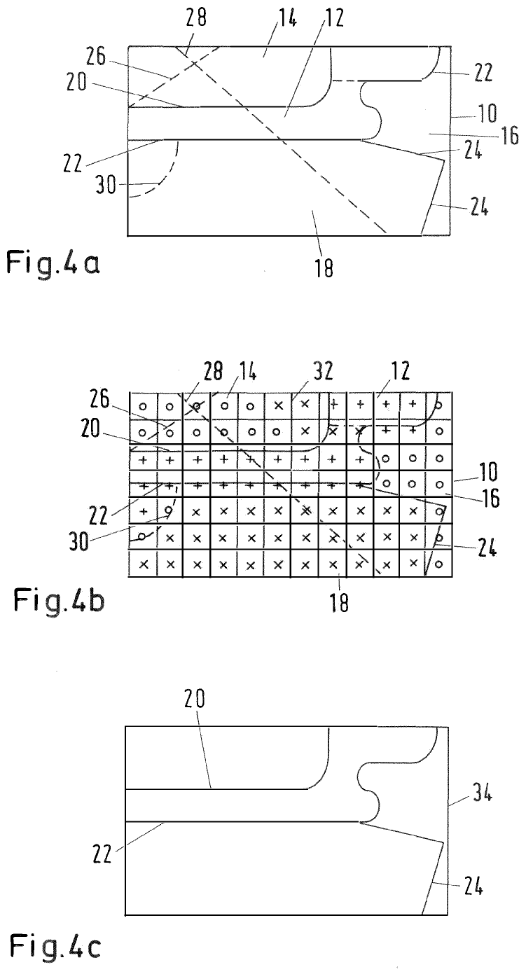

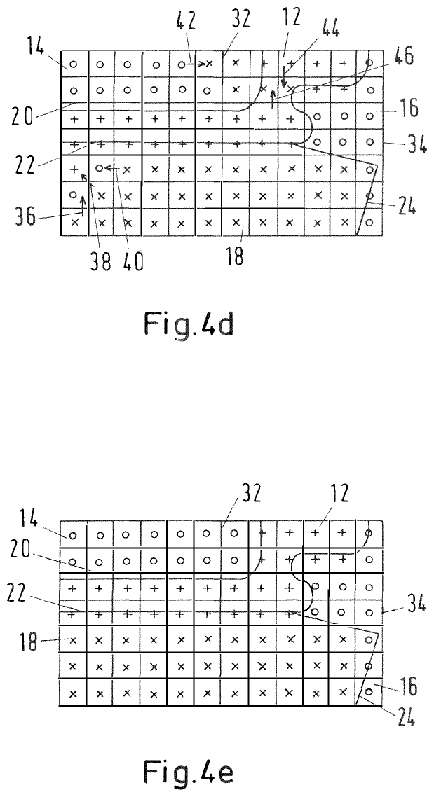

FIGS. 4a-e show a schematic illustration of a sequence of steps of an exemplary embodiment of the method.

The computer-implemented method for segmenting measurement data from a measurement of an object is denoted in its entirety below using the reference sign 100. The computer-implemented method 100 is first of all explained by means of FIG. 1.

FIG. 1 shows a flowchart of an embodiment of the computer-implemented method 100 for segmenting measurement data from a measurement of an object. In this case, the object has at least one material transition region.

In a first step 102, the measurement data relating to the object are determined. In this case, the measurement data can be determined, for example, by means of a computed tomography (CT) measurement. However, other methods for determining the measurement data, for example magnetic resonance imaging etc., are not excluded thereby. The measurement data are used to generate a digital object representation having the at least one material transition region. The digital object representation comprises a multiplicity of spatially resolved image information items relating to the object.

If the measurement data are CT data, they need not necessarily consist of only a single grayscale value per voxel. They may be multimodal data, that is to say data from a plurality of sensors, or data from a multi-energy CT scan, with the result that a plurality of grayscale values are present for each voxel. Furthermore, results from analyses on the original measurement data can also be used as a further spatially resolved grayscale value in the method 100, for example the result of an analysis of the fiber orientation or of the local porosity. The additional information items, which can be referred to as color channels for example, can therefore be interpreted like colored voxel data even though no colors of the visible spectrum are represented. These additional information items can be advantageously used in the method 100.

Further, the measurement data comprise at least one artifact. In this case, the measurement data include at least one artifact, that is to say they have a low data quality. The at least one artifact can be, e.g., a streak artifact, noise or other image defects.

In an optional step 112, a digital representation of a target geometry of the object is aligned with the digital object representation from the determined measurement data according to step 102. The digital representation of a target geometry of the object may be, for example, a CAD representation of the object which was created before producing the object. The geometry in the CAD model need not necessarily be described as a surface or material transition region. Instead or in addition, it may also be implicitly represented as a stack of images, a voxel volume or a distance field. This can be used during additive manufacturing, in particular. Furthermore, this information can be converted into a label field directly and without complicated conversion. However, further forms of representation of the target geometry are not excluded thereby.

During the alignment, that is to say when adapting the geometric regions of the target geometry to the measurement data, it is possible to take into account which materials are involved in the grayscale value transition and how they are arranged. The orientation of the material transition can emerge from the arrangement of the materials. This information is usually known in the target geometry and can be locally easily determined from the measurement data in each case. This makes it possible to prevent material transition regions which do not match one another from being assigned to one another, which would result in incorrect alignment.

The alignment can also be carried out by means of a non-rigid mapping between the measurement data and the target geometry.

At least two homogeneous regions are determined in the measurement data and/or in the digital object representation in a step 104 on the basis of the digital representation of the target geometry. To this end, the image information items are analyzed to the effect of whether homogeneous regions are present, for example regions within a grayscale value interval or with a similar texture. Since the material transition regions and the components of the object or the regions in the object with homogeneous materials are known in the digital representation of the target geometry, homogeneous regions in the measurement data or in the digital object representation generated from the measurement data can be deduced from the digital representation of the target geometry following the alignment in step 112.

In a step 106, the local similarity of the multiplicity of spatially resolved image information items is analyzed. In this case, a change sequence of the multiplicity of spatially resolved image information items can be analyzed, for example. Alternatively or in addition, a local variance of the multiplicity of spatially resolved image information items can be analyzed. The local variance can be calculated more quickly and more robustly at multi-material transition regions than the use of change sequences. Expected positions of the material transition regions between different components of the object can be determined from the local similarity. These expected positions of the material transition regions are the positions of expected boundaries of the homogeneous regions determined in step 104.

In a further step 108, the homogeneous regions are then adapted. For this purpose, the extent of each homogeneous region is changed, with the result that a boundary region of each homogeneous region is arranged at the expected position of a material transition region. The expected positions of the material transition regions therefore delimit the homogeneous regions in the object representation.

In a further step 110, at least two homogeneous regions from the digital object representation are segmented. Step 110, together with steps 106 and 108, can be referred to as main segmentation. In this case, determined homogeneous regions in the digital object representation are adapted and delimited from one another.

In step 110, information items from further sensors, for example in addition to the measurement data of a computed tomography measurement, can be used. When adapting the position of the material transition regions, the surface information items obtained with these sensors are used to extend the material transition regions in this direction or to prevent material transition regions from being extended beyond the surfaces determined in this manner.

In the optional step 118, a local similarity of the multiplicity of spatially resolved image information items in the segmented digital object representation can be changed for the purposes of correcting the analyzed local similarity. In the process, it is possible to highlight regions in which material transition regions are present in a user's opinion. In this case, anchor points are set, with the processing being able to be carried out as a material transition region and, as it were, as meta-information, instead of the image information items being changed directly in the representation of the local similarity.

Further, a local similarity changed by a user can be automatically adapted by way of suitable algorithms such that the changed local similarity collides with other regions that have an equivalent local similarity. This makes handling easier for the user since the accuracy with which the user must change the local similarity is reduced as a result of the assistance by the algorithm.

Subsequently, step 110 is repeated according to the further optional step 120 in order to obtain an improved segmentation.

In a further optional step 114, the position of the at least one material transition region in the at least one boundary region can be determined by means of the at least two homogeneous regions.

In this case, the position of the at least one material transition region can be determined on the basis of a label field, which for example was created in step 104 and for example adapted in step 108. A local material transition region is then calculated with increased accuracy. The position can be defined by coordinates.

The material transition regions which can represent a local surface, for example, are calculated with greater accuracy on the basis of the adapted label field. A further algorithm specialized for this can be used for this purpose. In this case, the exact position of the material transition region is searched for in a small surrounding area, for example a few voxels. This is usually the prerequisite for exact dimensional measurements which are intended to be carried out on CT data.

Different algorithms may, in principle, be used for this purpose, for example algorithms which work directly on the measurement data. They can determine the local position of the surface, for example by means of a local or global threshold or by searching for the maximum gradient or for a point of inflection of the grayscale value profile.

Furthermore, the exact local position of the material transition regions can be determined, for example, in the representation of the local similarity or the gradient or variance representation by adapting a second-degree polynomial to the grayscale value profile, for example. The position of the extremum of this polynomial can be used as the position of the surface.

However, further algorithms are not excluded by the explanations stated above.

The knowledge of the, possibly approximate, direction of a surface normal, of a surface arranged in the material transition region or of the materials arranged in the material transition region can be derived from the label field and the representation implicitly stored therein. This knowledge can be used by some algorithms to achieve more exact results. This knowledge, if available, can also be alternatively gathered from the desired geometry, for example a CAD model.

This is then carried out in combination with an algorithm which requires or can use the information relating to a starting surface to calculate the exact position of the surface on the basis thereof.

In a further optional step 116, an extent of at least one of the homogeneous regions can be changed on the basis of a visualization of the homogeneous regions in the digital object representation.

To this end, it is possible to mark individual regions of which it is known that they belong to a material. An algorithm is used to enlarge the relatively small marking up to the next material transition region so that a user can easily mark these regions.

In this case, in particular, algorithms for region growing or operations such as opening, closing, erosion and dilatation, the inversion, Boolean operators or smoothing tools such as filters can be used to process the regions in the label field.

The method further includes optional step 136, in which the multiplicity of image information items in the segmented digital object representation are changed by means of an artifact correction method based on the determined homogenous regions.

Hence, prior knowledge about the homogeneous regions can be used to carry out an artifact correction.

A further optional step 138 comprises the segmentation of the digital object representation on the basis of the multiplicity of adapted image information items obtained from step 136.

Hence, a high-quality segmentation then is available, in particular for objects with various homogeneous regions, that is to say regions with different homogeneity in this example. Hence knowledge about the geometry of the object is exploited for the correction in order to obtain, e.g., improved measurement data, optionally, if the measurement data are volume data, via the detour by way of corrected projection data. A segmentation of the various homogeneous regions accordingly allows the corrections to be carried out in optimized fashion. A new, more accurate segmentation is possible on the basis of the corrected data.

In a further optional step 140, steps 136 and 138 can be repeated until a predefined repetition condition is no longer satisfied. Hence, a new segmentation is carried out iteratively on the basis of the data corrected in steps 136 and 138.

In a further optional step 142, a material is assigned to each homogeneous region after step 110.

Further, a dimensional measurement in the segmented digital object representation can be carried out on the basis of the boundary regions in a further optional step 144. The dimensional measurement, which is based on the segmented measurement data or on the segmented digital object representation, can be carried out with very high accuracy as a result of the very accurate determination of the position of the material transition regions.

FIG. 2 illustrates optional sub-steps of step 108.

Step 108 may include the two optional sub-steps 122 and 124 in this case. In sub-step 122, at least one artifact region including at least one artifact is determined in the digital object representation on the basis of the at least two homogeneous regions and/or a digital representation of a target geometry. Hence, the digital representation of the target geometry or a preliminary segmentation of the digital object representation can be used to predict the regions of low data quality. On account of previous knowledge about the determination for the measurement data, this for example allows predictions to be made as to where artifacts such as streak artifacts or noise on account of a significant transillumination length of the object will occur in the measurement data or in the digital object representation. Hence, at least one boundary region can be determined in sub-step 124 on the basis of the analyzed local similarity, with a boundary region being determined in the artifact region if the local similarity between the image information items is lower than outside of the at least one artifact region.

Further, step 108 may include optional sub-steps 126, 128 and 130. Sub-step 126 relates to determining at least one geometry type of a volume region of the digital object representation. In sub-step 128, the determined geometry type is compared with geometry types from the target geometry of the object. Then, at least one boundary region is determined in sub-step 130 on the basis of the analyzed local similarity, with a boundary region being determined in the volume region if the local similarity between the image information items is lower than outside of the volume region and if the determined geometry type is not similar to any of the geometry types from the target geometry of the object. Hence, the homogeneous regions are analyzed in respect of their geometry types arranged there and are compared with the geometry types that should be present in the object. In this case, prior knowledge that geometries of a certain type cannot be present in the object, for example plane surfaces in foam structures, is used. Corresponding regions of reduced homogeneity which reproduce such geometry types are accordingly identified less frequently as a material transition region in the main segmentation.

Step 108 may further include the optional sub-steps 132 and 134. A quality value of at least one volume region of the digital object representation is determined in sub-step 132. In this case, the quality value specifies a quality or uncertainty of an image information item. Here, the quality value can be calculated for each image information item, for example a voxel or volume region, a type of quality or uncertainty of a grayscale value. In the process, real projection data can be compared to a forward projection, that is to say a calculated projection on the basis of the reconstruction, for example. This can be used for an estimate for where in the volume the data quality is expected to be low since inconsistent measurement data are available for these positions.

Then, at least one boundary region is determined in sub-step 134 on the basis of the analyzed local similarity in the volume region if the local similarity between the image information items is lower than outside of the volume region and if the determined quality value for the at least one volume region is smaller than a predefined threshold for the quality value. Here, the predefined threshold can be specified by a user or an evaluation rule.

FIG. 3 shows an example of a multi-material transition region having multiple edges. In this case, the materials 48, 54 and 56 are illustrated in FIG. 3. In this case, the material 48 is arranged between the materials 54 and 56 and has a very short extent in comparison with the other two materials. The material transition region 52 is arranged between the material 48 and the material 54. The material transition region 50 is arranged between the material 48 and the material 56. Overall, the two material transition regions 50 and 52 form a multi-material transition region which can be resolved only with difficulty using conventional methods. Conventional segmentation methods generally detect such regions as merely one material transition region. However, a plurality of material transition regions which are very close together can be detected using the computer-implemented method 100 of the invention described above.

An example of steps 104, 106 and 108, optional step 142 and some more steps of the method 100 are explained in more detail below by means of FIGS. 4a to 4e, which represent a use of a label field in the context of the method 100. In this case, FIG. 4a schematically shows a digital representation 10 of image information items from measurement data relating to a section of an object. This schematic digital object representation may be, for example, a sectional representation of a computed tomography measurement. In this case, the image information items may be grayscale values which, for reasons of clarity, are not illustrated as grayscale values in FIG. 4a.

Only transition regions in which the grayscale values change greatly are illustrated as lines.

The object has the subregions 12, 14, 16 and 18, the image information items of which respectively form homogeneous regions. The subregion 12 is delimited from the subregion 14 by means of the material transition region 20. The subregion 12 is delimited from the subregions 16 and 18 by means of the material transition region 22. The material transition region 24 is arranged between the subregion 16 and the subregion 18. However, in the digital representation 10 of the image information items, the transition regions 26, 28 and 30 can also be seen, but result from shadowing or other artifacts and are not material transition regions.

In this case, conventional algorithms have problems with distinguishing the transition regions 26, 28 and 30 from material transition regions 20, 22 and 24. Therefore, it is possible to initially carry out an optional pre-segmentation in which the image information items are analyzed.

In this case, FIG. 4b illustrates the representation 10 of the image information items from FIG. 4a with a grid as a label field 32. The label field 32 may have any desired resolution and may be, for example, coarser than the resolution of the voxels or pixels, may have voxel/pixel accuracy or subvoxel/subpixel accuracy. The label field 32 and/or the distance field will in most cases have the same structure and resolution as the measurement data. However, a lower resolution and therefore larger cells, or an anisotropic resolution and therefore cuboids instead of cubes, can be selected, for example. Further, the structure can also be adapted, for example tetrahedrons instead of cubes. In addition, it is not absolutely necessary to make it possible to represent the material transition regions with subvoxel accuracy with the aid of one or more distance fields. This may become necessary only when or after determining the position of the material transition regions. Therefore, computing time and storage space can be saved if work is carried out only on the label field during segmentation and distance fields are used only when determining the positions of the material transition regions.

If the image information items are grayscale values, for example, grayscale values below a certain threshold can be assigned to a first material, for example air, which is indicated with the label “o” in FIG. 4b. Grayscale values above a further threshold are assigned to a second material which is illustrated with the label “+” in FIG. 4b. Grayscale values which are between the two thresholds can be assigned to a third material which is indicated with the “x” in FIG. 4b.

The label field can be combined with a distance field.

Further, the information items from the target geometry relating to the individual parts of the object, for example in the case of connectors having numbered pins 1-9, can be used to obtain information items relating to the respective materials. Therefore, regions of the same material can also be divided among different parts of the object. In this manner, the practice of evaluating the measurement data becomes clearer. Ideally, the regions are listed or indicated in a hierarchical structure already defined in the target geometry.

In a similar manner, the regions of the same material which are separated or are not connected in the label field can also be automatically divided into different parts.

In a next step according to FIG. 4c, a representation 34 which is obtained from analyzing the local similarity of the image information items is determined. This may be a gradient representation, for example. Here, the material transition regions 20 and 22 and 24 are clearly discernible. The transition regions 26 to 30 cannot be seen in this representation. However, in contrast to the representation 10 of the image information items, the individual subregions of the object cannot be qualitatively distinguished from one another. That is to say, the material of a subregion cannot be inferred from the representation according to FIG. 4c.

The representation 34 is linked to the label field 32, as is illustrated by way of example in FIG. 4d. In this case, it becomes discernible that the homogeneous regions are not delimited by the material transition regions 20, 22 and 24 in all sections. The boundaries of the homogeneous regions are therefore shifted during a main segmentation by relabeling homogeneous regions, for example from “o” to “x” at the arrows 36 and 40 and from “+” to “x” at the arrow 38. The region which had the label “o” at the arrows 36 and 40 has disappeared in FIG. 4e and now belongs to the region with the label “x”. The region with the label “+” was reduced at the arrow 38 and the region with the label “o” was increased. A similar process takes place at the arrows 42, 44 and 46. At the arrows 46 and 44, two previously separate homogeneous regions with the label “+” grow together, with a region with the label “x” disappearing.

Alternatively or in addition, individual regions which belong to a material can be marked in the digital object representation in order to create the label field. The marking is intelligently automatically extended to the next material transition region. It is also possible to allow a material transition region to be indicated by a user and to automatically increase it until the material transition region collides with other material transition regions, for example, with the result that the user is not forced to indicate a complete material transition region. Accurate marking is therefore not necessary. Furthermore, operations such as opening, closing, erosion and dilatation, an inversion, Boolean operators or smoothing tools such as filters can be used to process the regions in the label field.

Furthermore, it is possible to highlight regions in which material transition regions are present in a user's opinion. In this case, anchor points are set, with the processing being able to be carried out as a material transition region and, as it were, as meta-information, instead of the image information items being changed directly in the representation of the local similarity.

Alternatively, erroneous material transition regions can also be removed or weakened. After processing, the label field is recalculated on this basis. In this case, it is also possible to output a warning if no meaningful material transition region can be found at the location defined by the user.

A surface-based determination of a local data quality can also be used. In this case, a quality value representing the accuracy of the material transition region can be assigned to each material transition region.

The representation of the local similarity can be calculated from the measurement data, in particular from volume data, using different methods. For example, a Sobel operator, a Laplace filter or a Canny algorithm can be used. The choice of which algorithm is used and how it is parameterized can be manually made by the user. For example, that algorithm which produces the best results when creating the label field can be selected on the basis of a preview image. In addition, the representation of the local similarity can be processed by means of filtering before adapting the label field in order to achieve the best possible results. An example would be the use of a Gaussian filter in order to minimize the negative influence of noise on the result when adapting the label field.

Depending on the algorithm, it is possible for even smaller regions to be incorrectly segmented after the label field has been adapted. In order to rectify this, sub-steps can optionally also be carried out.

In this case, morphological operators such as opening and/or closing can be applied to the individual material regions, thus removing small regions.

Furthermore, contiguous regions below a defined maximum size can be deleted and can be assigned to the surrounding material(s). Regions which are surrounded by two or more other materials can optionally be provided with a differing or larger maximum size or cannot be deleted at all, whereas regions which are surrounded only by one other material are still treated with the above-mentioned maximum size. In this manner, thin layers of a material between two further materials can be retained, for example.

FIG. 4e shows the result of the main segmentation. Here, the boundaries of the label fields correspond approximately to the material transition regions 20, 22 and 24. The components or materials 12, 14 and 16 are therefore segmented.

The material transition regions which can represent a local surface, for example, are calculated with greater accuracy on the basis of the adapted label field. A further algorithm specialized for this can be used for this purpose. In this case, the exact position of the material transition region is searched for in a small surrounding area, for example a few voxels. This is usually the prerequisite for exact dimensional measurements which are intended to be carried out on CT data.

Different algorithms may, in principle, be used for this purpose, for example algorithms which work directly on the measurement data. They can determine the local position of the surface, for example by means of a local or global threshold or by searching for the maximum gradient or for a point of inflection of the grayscale value profile.

Furthermore, the exact local position of the material transition regions can be determined, for example, in the representation of the local similarity or the gradient or variance representation by adapting a second-degree polynomial to the grayscale value profile, for example. The position of the extremum of this polynomial can be used as the position of the surface.

However, further algorithms are not excluded by the explanations stated above.

The knowledge of the, possibly approximate, direction of a surface normal, of a surface arranged in the material transition region or of the materials arranged in the material transition region can be derived from the label field and the representation implicitly stored therein. This knowledge can be used by some algorithms to achieve more exact results. This knowledge, if available, can also be alternatively gathered from the desired geometry, for example a CAD model.

This is then carried out in combination with an algorithm which requires or can use the information relating to a starting surface to calculate the exact position of the surface on the basis thereof.

Furthermore, cone beam artifacts, sampling artifacts and noise can be reduced before or after creating the label field.

The invention is not restricted to one of the embodiments described above, but rather can be modified in various ways.

All of the features and advantages emerging from the claims, the description and the drawing, including design details, spatial arrangements and method steps, can be essential to the invention both alone and in the wide variety of combinations.

1. A computer-implemented method for segmenting measurement data from a measurement of an object, the object having at least one material transition region, a digital object representation with the at least one material transition region being generated by way of the measurement data, the digital object representation having a multiplicity of spatially resolved image information items of the object, the method including the following steps:
determining the measurement data, the measurement data containing at least one artifact;
determining at least two homogeneous regions in the measurement data and/or in the digital object representation;
analyzing a local similarity of the multiplicity of spatially resolved image information items;
adapting an extent of each homogeneous region until at least one boundary region of each homogeneous region is arranged at an expected position of a material transition region;
segmenting the digital object representation on the basis of the adapted homogeneous regions.

2. The method as claimed in claim 1, wherein the at least one material transition region is a multi-material transition region.

3. The method as claimed in claim 1, wherein the analysis of the local similarity is based on a change sequence of the multiplicity of spatially resolved image information items and/or a local variance of the multiplicity of spatially resolved image information items.

4. The method as claimed in claim 1, wherein the method further includes the following step that precedes the determination of at least two homogeneous regions of the digital object representation:
aligning a digital representation of a target geometry with the digital object representation;
with the determination of at least two homogeneous regions being carried out on the basis of the digital representation of a target geometry.

5. The method as claimed in claim 1, wherein the method further includes the following step after the step of segmenting the digital object representation:
determining the position of the at least one material transition region in the at least one boundary region by means of the at least two homogeneous regions.

6. The method as claimed in claim 1, wherein the method further includes the following step after the segmentation of the digital object representation:
changing an extent of at least one of the homogeneous regions on the basis of a visualization of the homogeneous regions in the digital object representation.

7. The method as claimed in claim 1, wherein the method further includes the following steps after the segmentation of the digital object representation:
changing a local similarity of the multiplicity of spatially resolved image information items in the segmented digital object representation for the purposes of correcting the analyzed local similarity; and
repeating the step of segmenting the digital object representation on the basis of the corrected analyzed local similarity.

8. The method as claimed in claim 1, wherein the step of adapting an extent of each homogeneous region until at least one boundary region of each homogeneous region is arranged at an expected position of a material transition region includes the following sub-step:
determining at least one artifact region containing at least one artifact in the digital object representation on the basis of the at least two homogenous regions and/or a digital representation of a target geometry;
determining at least one boundary region on the basis of the analyzed local similarity, with a boundary region being determined in the artifact region if the local similarity between the image information items is lower than outside of the at least one artifact region.

9. The method as claimed in claim 1, wherein the step of adapting an extent of each homogeneous region until at least one boundary region of each homogeneous region is arranged at an expected position of a material transition region includes the following sub-steps:
determining at least one geometry type of a volume region of the digital object representation;
comparing the determined geometry type with geometry types from a target geometry of the object;
determining at least one boundary region on the basis of the analyzed local similarity, with a boundary region being determined in the volume region if the local similarity between the image information items is lower than outside of the volume region and if the determined geometry type is not similar to any of the geometry types from the target geometry of the object.

10. The method as claimed in claim 1, wherein the step of adapting an extent of each homogeneous region until at least one boundary region of each homogeneous region is arranged at an expected position of a material transition region includes the following sub-steps:
determining a quality value of at least one volume region of the digital object representation;
determining at least one boundary region on the basis of the analyzed local similarity in the volume region if the local similarity between the image information items is lower than outside of the volume region and if the determined quality value for the at least one volume region is smaller than a predefined threshold for the quality value.

11. The method as claimed in claim 1, wherein the method further includes the following steps after the segmentation of the digital object representation:
adapting the multiplicity of image information items in the segmented digital object representation by means of an artifact correction method based on the determined homogeneous regions; and
segmenting the digital object representation on the basis of the multiplicity of adapted image information items.

12. The method as claimed in claim 11, wherein the method further includes the following step:
repeating the steps of: adapting the multiplicity of image information items in the segmented digital object representation by means of an artifact correction method based on the determined homogeneous regions and segmenting the digital object representation on the basis of the multiplicity of adapted image information items for as long as a predefined repetition condition is satisfied.

13. The method as claimed in claim 1, wherein a material is assigned to each homogeneous region following the segmentation of the digital object representation.

14. The method as claimed in claim 1, wherein the method further includes the following step after the segmentation of the digital object representation:
performing a dimensional measurement in the segmented digital object representation on the basis of the boundary regions.

15. A computer program product with instructions which are executable on a computer and which
when executed on a computer prompt the computer to carry out the method as claimed in claim 1.
